(19) United States
(12) Patent Application Publication
(10) Pub. No.: US 2012/0246961 A1
(43) Pub. Date: Oct. 4, 2012

(54) Heat transfer device for residential, commercial, or industrial clothes dryer

(76) Inventor: Lisa A. Atkins, Phoenix, AZ (US)

(21) Appl. No.: 13/134,783

(22) Filed: Sep. 19, 2011

(51) Int. Cl. F26B 11/02; F26B 19/00

(52) U.S. Cl. 34/108; 34/523

(57) ABSTRACT

This invention relates to an improved method and apparatus for speeding up the drying process in the clothes dryer, saving the consumer time, energy, and the cost of that energy.

### CROSS REFERENCE TO RELATED APPLICATIONS

Not applicable

### STATEMENT REGARDING FEDERALLY SPONSORED RESEARCH

Not applicable

### NAMES OR PARTIES TO A JOINT RESEARCH AGREEMENT

Not applicable

### INCORPORATION BY REFERENCE SUBMITTED ON COMPACT DISC

Not applicable

### BACKGROUND OF INVENTION

1. Technical Field

The present invention is in the technical field of Heat transfer. More particularly the object of this apparatus is to absorb heat from the clothes dryer as it tumbles and then transfers that heat by coming in contact with the wet articles of clothing, in turn accelerating evaporation and speeding up the drying process.

2. Related Art

Today's clothes dryers consist of a rotating drum known as a tumbler. Hot air is circulated through the tumbler to remove moisture from the wet load. The tumbler rotates to maintain space between the articles to be dried, and this is when evaporation occurs. In some instances, the tumbling of the load is limited due to centrifugal force that is generated by the rotation of the drum during operation. Therefore articles that have limited circulation take more time to dry. This in effect is solved by the present invention by its unique design and ability to distribute the hot air and clothing throughout the entire space of the tumbler. This invention is based on 3 principles that influence the rate of evaporation.

1. The greater the surface area of heat, the more surface molecules are able to escape and evaporation occurs faster.

2. Evaporation occurs faster if there is less pressure on the surface of the clothing keeping molecules of water from launching themselves.

3. If the temperature of the tumbler is hotter, then its molecules have a higher average kinetic energy and evaporation will occur faster.

### BRIEF SUMMARY OF INVENTION

This invention proposes that when used in conjunction with a Residential, Commercial, or Industrial clothes dryer, it facilitates the removal of moisture from wet laundry by increasing the surface area of heat, which increases the rate of evaporation of moisture. It also achieves this increased evaporation by facilitating the tumbling of the wet load of clothing. In essence, it is a hot element tumbling within a wet load of clothing.

### BRIEF DESCRIPTION OF DRAWING

In order that the invention be better understood, it will be described with reference to the accompanying drawings.

FIG. 1 Shows the invention in its entirety

FIG. 2 Shows a perspective view of the layers of the invention.

FIG. 3 Shows a vertical cross section of the layers.

FIG. 4 Shows the elements of the invention in its completed state.

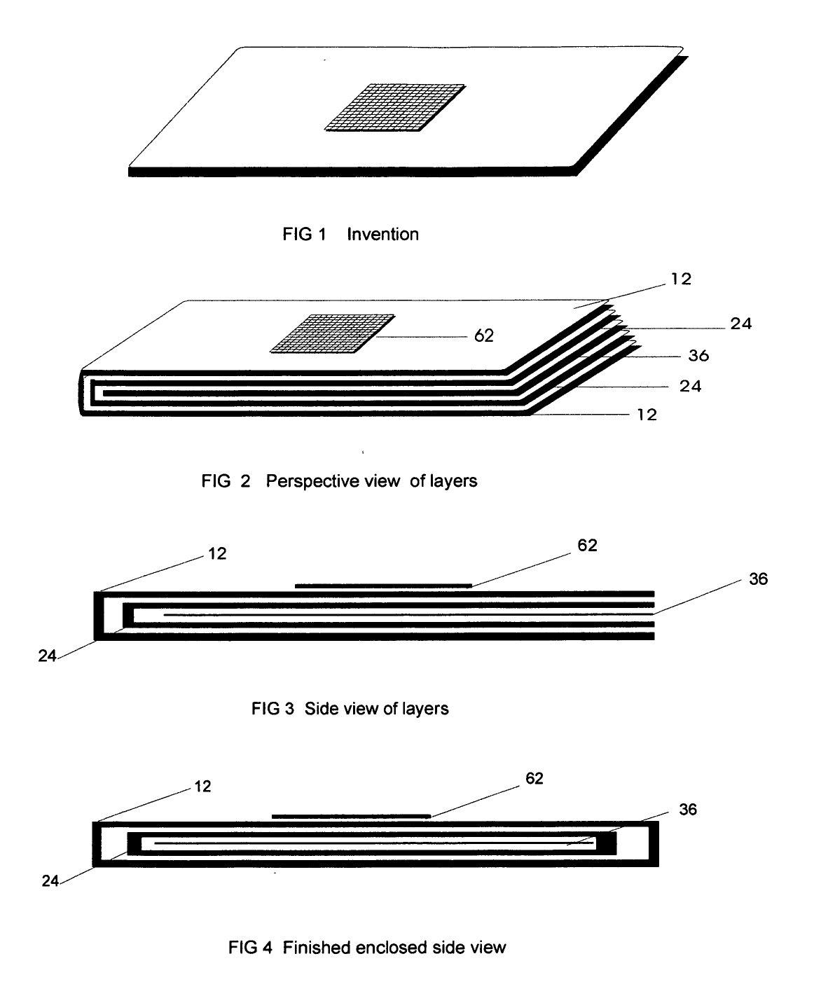

Parts and Nomenclature for FIG. 3
Part number: 36 : 18 in.×24 in. sheet metal.
UPN number: ______.
Part number: 24 : 18.25 in.×24.25 in. Padded bubble foil sleeve.
UPN number: ______.
Part number: 12 : 18.5 in.×24.5 in. Nylon fabric sleeve.
UPN number: ______.
Part number: 62 : 6 in.×10 in. Ventilated fabric pocket
UPN number: ______.
UPN numbers to be provided at a later date.

### DETAILED DESCRIPTION OF INVENTION

Generally speaking this invention pertains to a device that accelerates the process of drying a load of wet clothing in a residential, commercial, or industrial clothes dryer. The invention accomplishes the above objective by the following techniques. The device increases the surface area of heat, therefore increasing the rate of evaporation.

The device also facilitates the tumbling of the clothing, therefore exerting less pressure on the individual items allowing for increased evaporation.

The device is placed in the tumbler of the dryer in its normal state which is dry. As the dryer is turned on, the device tumbles along with the wet load and quickly absorbs heat from the dryer. The heated device comes in contact with the wet articles of clothing over and over again through the tumbling action of the clothes dryer, speeding up the drying process. The device helps to facilitate the distribution of clothing and hot air throughout the entire space of the dryer, allowing for faster drying.

In reference to FIG. 3, part number 36. This is a piece of 30 gauge sheet metal. Its Function is to absorb heat from the dryer tumbler, hold, and transfer that heat to the wet articles of clothing while tumbling.

It is then slipped into a padded bubble foil sleeve, FIG. 3 part number 24, and then sewn shut at the open end. This sleeve serves as padding for part number 36, and it also retains heat.

Then a ventilated pocket, FIG. 3 part number 62, is sewn onto the nylon sleeve. Its purpose is to hold fabric softener sheets.

Then the device is slipped into the nylon sleeve, FIG. 3 part number 12, and it is sewn shut at the open end. Its function is to serve as an outside covering for the heat transfer device.

FIG. 4 shows the device in its completed state ready for use. The overall size of the device will be relative to the size of the dryer. In essence, the device functions at its best when used to dry consecutive loads of wet fabric or clothing.

1. I claim that the said device, when used in conjunction with a residential, commercial, or industrial clothes dryer, speeds up the drying process of wet articles of fabric or clothing. Speeding up this drying process saves on the amount of time the clothes dryer is in use, therefore less use of said dryer will result in lower energy consumption and lower energy costs for the consumer.
a. A device according to claim 1 in which absorbs heat from said dryer and transfers that heat through contact with said wet articles as it tumbles throughout the tumbler of said clothes dryer.
b. A device according to claim 1, when added to said clothes dryer, increases the heated surface area within the dryer, therefore increasing the rate at which moisture is evaporated from said wet articles of fabric or clothing.
c. A device according to claim 1, that facilitates the tumbling of said wet articles of clothing in turn accelerating the drying process. It accomplishes this by tumbling and flexing within the dryer tumbler which creates more freedom of movement. It also allows for an increased distribution of said articles of clothing and hot air throughout the entire space of the dryer tumbler.
